(19) United States
(12) Patent Application Publication
(10) Pub. No.: US 2026/0208337 A1
(43) Pub. Date: Jul. 23, 2026

(54) AIR INFLATION AND STORAGE STRUCTURE OF AIR CYLINDER FOR PNEUMATIC TOOL

(71) Applicant: Feng REN, Ningbo (CN)

(72) Inventor: Feng REN, Ningbo (CN)

(21) Appl. No.: 19/139,436

(22) PCT Filed: Dec. 2, 2024
(86) PCT No.: PCT/CN2024/136056

§ 371 Date: Jun. 16, 2025

(30) Foreign Application Priority Data
Oct. 11, 2023 (CN) 202322736854.3

(51) Int. Cl. B25C 1/04

(52) U.S. Cl. CPC B25C 1/047

(57) ABSTRACT

Disclosed is an air storage structure of an air cylinder for a pneumatic tool, including a pneumatic tool body, an air cylinder being disposed in the pneumatic tool body. In the air storage structure of an air cylinder for a pneumatic tool, a working air chamber and an air storage chamber connectable to each other are disposed in the air cylinder, a driving device is disposed in the pneumatic tool body, the driving device is connected to a driving shaft, the driving shaft is provided with an air storage driving member and a firing pin lift driving member, the air storage driving member and the firing pin lift driving member both rotate unidirectionally and rotate in opposite directions, and a piston connecting rod driven to reciprocate by the air storage driving member is disposed in the air storage chamber. The air storage structure of an air cylinder for a pneumatic tool has the following advantages: the structure is rational and compact, the lifting of the firing pin or air storage for the air cylinder is realized by a forward or reverse rotation of the driving shaft, and the air storage for the air cylinder is realized by means of the air storage chamber, which can increase a firing force of the firing pin.

### TECHNICAL FIELD

The present disclosure relates to the technical field of pneumatic tool manufacturing, and in particular to an air inflation and storage structure of an air cylinder for a pneumatic tool.

### BACKGROUND ART

Pneumatic tools are tools that use air pressure as a power source, such as pneumatic nail guns. The pneumatic nail gun uses air pressure in an air reservoir to strike a firing pin, realizing nail firing by the striking of the firing pin on a nail.

For example, the patent application, with application number CN202320701616.6, and entitled “PNEUMATIC NAIL GUN AND NAILING COMPONENT THEREOF”, discloses a pneumatic nail gun, which includes an air cylinder, a piston, a nailing rod, a nailing block and a sealing plate. The piston is slidingly mounted in the air cylinder, and the piston includes a ring and a hollow extension cylinder with an opening at one end; one end of the nailing rod is connected to the nailing block, and the other end of the nailing rod is connected to the ring; the sealing plate is provided with an air inlet; one end of the extension cylinder is connected to the ring, and the other end of the extension cylinder movably abuts against the sealing plate; and the opening of the extension cylinder is directed to the air inlet. However, it is only used to generate air pressure by compressing air in the air cylinder when a firing pin is lifted, and the air pressure is small, which results in a weak penetration force of the nail gun. Therefore, the structure of the pneumatic nail gun needs to be further improved.

### SUMMARY

An objective of the present disclosure is to disclose, to the society, an air inflation and storage structure of an air cylinder for a pneumatic tool that is rational and compact and capable of increasing a firing force of a firing pin, in order to make up for deficiencies mentioned above.

The technical solution of the present disclosure is implemented as follows:

An air inflation and storage structure of an air cylinder for a pneumatic tool includes a pneumatic tool body, an air cylinder being disposed in the pneumatic tool body, where a working air chamber and an air storage chamber connectable to each other are disposed in the air cylinder, a driving device is disposed in the pneumatic tool body, the driving device is connected to a driving shaft, the driving shaft is provided with an air inflation and storage driving member and a firing pin lift driving member, the air inflation and storage driving member and the firing pin lift driving member both rotate unidirectionally and rotate in opposite directions, and a piston connecting rod driven to reciprocate by the air inflation and storage driving member is disposed in the air storage chamber.

Measures to further optimize the technical solution are as follows:

As an improvement, the air inflation and storage driving member is a driving gear meshing with a driven gear, the driven gear is disposed on a cam gear shaft, a cam is also disposed on the cam gear shaft, and an end of the piston connecting rod is connected to the cam. The driven gear is driven by the driving gear, to allow the cam gear shaft to rotate, so that the piston connecting rod is driven to reciprocate in the air storage chamber by the cam.

As an improvement, a mounting bracket is disposed in the pneumatic tool body, and the cam gear shaft is rotatably mounted on the mounting bracket. The mounting bracket extends toward one side of the driving device to form a mounting platform so as to provide conditions for the mounting of the cam gear shaft.

As an improvement, the mounting bracket is provided with a guard formed outside the cam gear shaft. The guard is provided as a physical barrier outside the driven gear to prevent debris from entering and then causing the gears to get stuck.

As an improvement, a unidirectional bearing is disposed between the driving shaft and the air inflation and storage driving member, and a unidirectional bearing is also disposed between the driving shaft and the firing pin lift driving member. The unidirectional rotation of the air inflation and storage driving member and the firing pin lift driving member is realized by the arrangement of the unidirectional bearings, which simplifies the structure.

As an improvement, the driving device is a motor, and a speed reducer is connected to the motor.

As an improvement, the firing pin lift driving member cooperates with a firing pin, and a tail end of the firing pin is disposed within the working air chamber.

As an improvement, the working air chamber and the air storage chamber are arranged in parallel. This arrangement enables a more compact structure.

Compared with the prior art, the present disclosure has the following advantages:

The air inflation and storage structure of an air cylinder for a pneumatic tool according to the present disclosure has a rational structure. Since the air inflation and storage driving member and the firing pin lift driving member are coaxially disposed on the driving shaft, and the air inflation and storage driving member and the firing pin lift driving member both rotate unidirectionally and rotate in opposite directions, it achieves the purposes of lifting the firing pin when the driving shaft rotates forwardly and storing air for the air cylinder when the driving shaft rotates reversely, and two functions are achieved with the same driving shaft, which makes the structure of the pneumatic tool more compact; and air storage for the air cylinder is realized by means of the air storage chamber, which can improve a firing force of the firing pin.

### BRIEF DESCRIPTION OF THE DRAWINGS

FIG. 1 is a perspective structural diagram of an embodiment of the present disclosure;

FIG. 2 is an enlarged view of part A in FIG. 1;

FIG. 3 is a schematic structural diagram of the fitting between an air inflation and storage driving member and a cam gear shaft in FIG. 1;

FIG. 4 is a schematic structural diagram of FIG. 3 with a mounting bracket removed; and

FIG. 5 is a sectional structural diagram of an air cylinder in FIG. 1.

List of reference signs in the figures of the present disclosure:
pneumatic tool body 1, mounting bracket 11, guard 11a, air cylinder 2, working air chamber 2a, air storage chamber 2b, driving device 3, speed reducer 31, driving shaft 4, air inflation and storage driving member 5, firing pin lift driving member 6, piston connecting rod 7, cam gear shaft 8, driven gear 81, cam 82, firing pin 9.

### DETAILED DESCRIPTION OF EMBODIMENTS

The present disclosure will be described in further detail below with reference to the accompanying drawings.

The following description is for purposes of disclosing the present disclosure so that those skilled in the art can implement the present disclosure. The preferred embodiments in the following description are by way of example only, and other obvious variations are conceivable to those skilled in the art. The basic principles of the present disclosure defined in the following description may be used in other embodiments, variations, improvements, equivalents, and other technical solutions that do not depart from the spirit and scope of the present disclosure.

It should be understood by those skilled in the art that orientations or positional relationships indicated by the terms “longitudinal”, “transverse”, “upper”, “lower”, “left”, “right”, “front”, “rear”, “vertical”, “horizontal”, “top”, “bottom”, “inner”, “outer”, etc. are based on the orientation or positional relationship shown in the accompanying drawings and are only for facilitating the simplified description of the present disclosure, rather than indicating or implying that an apparatus or an element referred to must have a particular orientation or be constructed and operated in a particular orientation, and therefore the terms will not be interpreted as limiting the present disclosure.

It can be understood that the term “a/an” is to be understood as “at least one” or “one or more”, i.e., in one embodiment, the number of elements may be one, and in other embodiments, the number of the elements may be multiple, the term “a/an” shall not be understood as a limitation on the number.

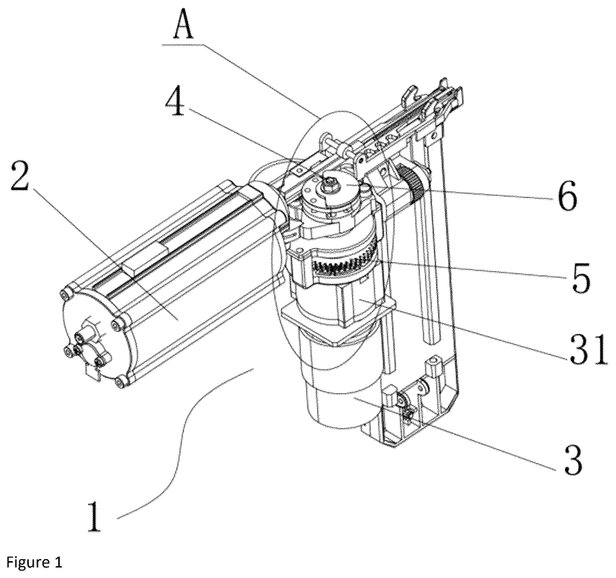

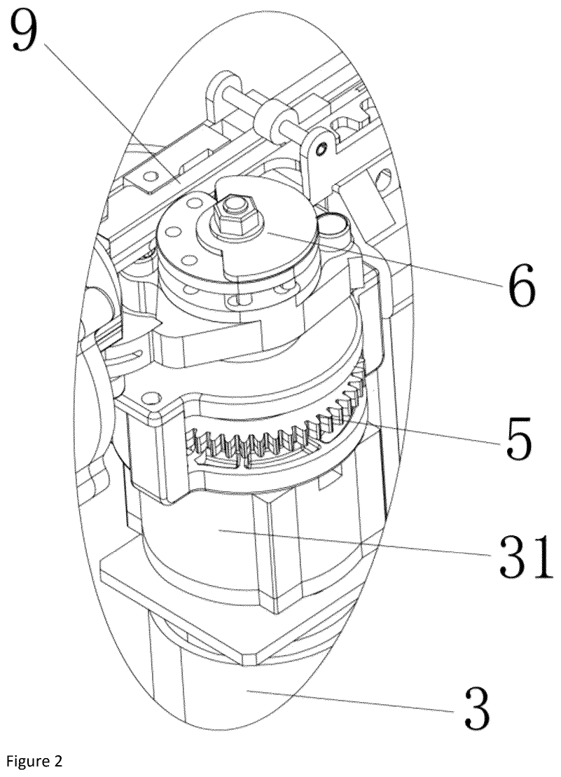

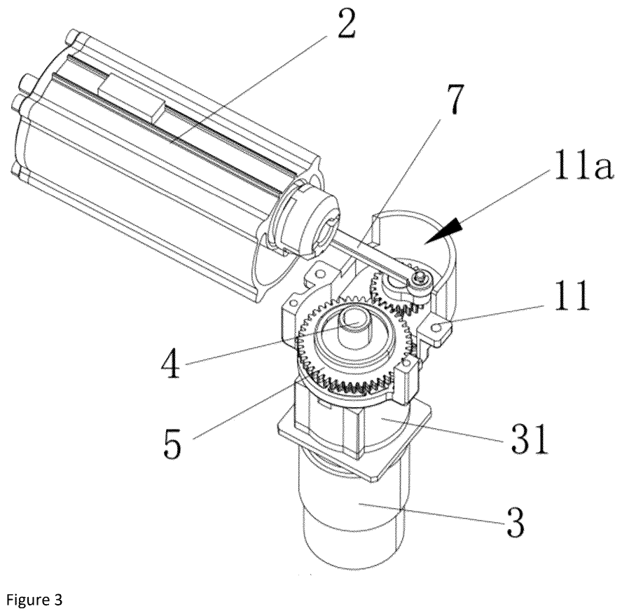

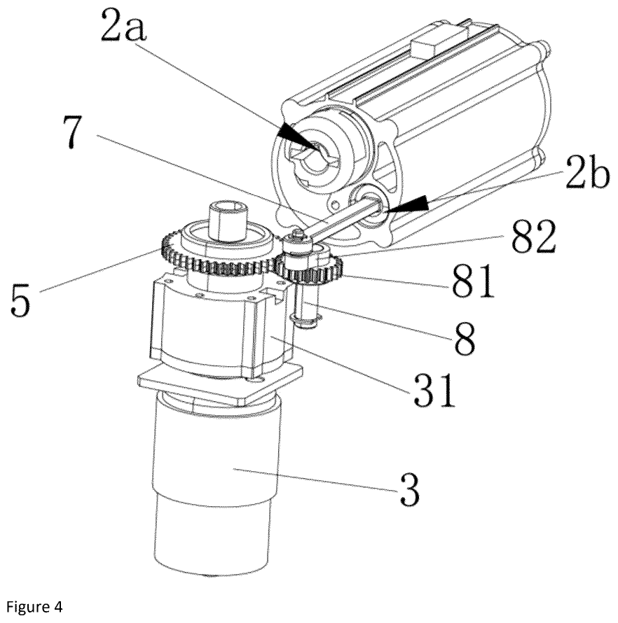

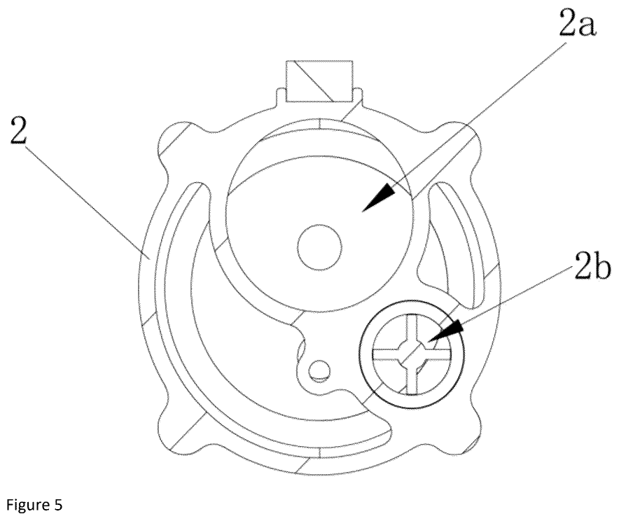

As shown in FIGS. 1 to 5, an air inflation and storage structure of an air cylinder for a pneumatic tool includes a pneumatic tool body 1, an air cylinder 2 being disposed in the pneumatic tool body 1. In the air inflation and storage structure of an air cylinder for a pneumatic tool, a working air chamber 2a and an air storage chamber 2b connectable to each other are disposed in the air cylinder 2, a driving device 3 is disposed in the pneumatic tool body 1, the driving device 3 is connected to a driving shaft 4, the driving shaft 4 is provided with an air inflation and storage driving member 5 and a firing pin lift driving member 6, the air inflation and storage driving member 5 and the firing pin lift driving member 6 both rotate unidirectionally and rotate in opposite directions, and a piston connecting rod 7 driven to reciprocate by the air inflation and storage driving member 5 is disposed in the air storage chamber 2b.

The above driving device 3 is preferably a motor, and a speed reducer 31 is connected to the motor. A housing (not shown in the figures) is provided outside the pneumatic tool body 1.

The air inflation and storage driving member 5 is a driving gear meshing with a driven gear 81, the driven gear 81 is disposed on a cam gear shaft 8, a cam 82 is also disposed on the cam gear shaft 8, and an end of the piston connecting rod 7 is connected to the cam 82. The piston connecting rod 7 is driven to reciprocate by the cam 82 on the cam gear shaft 8, which simplifies the structure.

A mounting bracket 11 is disposed in the pneumatic tool body 1, and the cam gear shaft 8 is rotatably mounted on the mounting bracket 11.

The mounting bracket 11 is provided with a guard 11a formed outside the cam gear shaft 8.

The mounting bracket 11 extends toward one side of the driving device 3 to form a mounting platform so as to provide conditions for the mounting of the cam gear shaft 8. The guard 11a is provided as a physical barrier outside the driven gear 81 to prevent debris from entering and then causing the gears to get stuck, thereby reducing a failure rate.

A unidirectional bearing is disposed between the driving shaft 4 and the air inflation and storage driving member 5, and a unidirectional bearing is also disposed between the driving shaft 4 and the firing pin lift driving member 6. The driving shaft 4 of the present disclosure is provided with two components capable of rotating unidirectionally, i.e., the air inflation and storage driving member 5 and the firing pin lift driving member 6. Herein, the unidirectional rotation of the components is achieved by means of the unidirectional bearings, which simplifies the structure and can also ensure compactness of the structure.

The firing pin lift driving member 6 cooperates with a firing pin 9, and a tail end of the firing pin 9 is disposed within the working air chamber 2a.

The working air chamber 2a and the air storage chamber 2b are arranged in parallel. This arrangement enables a compact structure.

### Operation Principle

According to the pneumatic tool, the motor drives the driving shaft 4 to rotate, and the driving shaft 4 rotates forwardly or reversely to realize lifting of the firing pin 9 or air storage for the air cylinder 2.

When the motor rotates forwardly, the driving shaft 4 drives the firing pin lift driving member 6 to rotate, with the air inflation and storage driving member 5 not rotating. In this embodiment, the firing pin has a two-stage lifting structure. The firing pin lift driving member 6 is provided with a driving block and a plurality of driving posts spaced apart from each other, and the firing pin is provided with a bump and a rack. As the firing pin lift driving member 6 rotates, the driving block transmits a force to the bump of the firing pin 9 via a transition member (the transition member is disposed across the firing pin 9), thereby achieving a first-stage lifting. After the first-stage lifting, the firing pin lift driving member 6 continues to rotate, and then the driving posts act one by one on corresponding teeth of the rack of the firing pin 9 to complete a second-stage lifting.

When the motor rotates reversely, the driving shaft 4 drives the air inflation and storage driving member 5 to rotate, with the firing pin lift driving member 6 not rotating. The driving gear (i.e., the air inflation and storage driving member 5) rotates to drive the cam gear shaft 8 to rotate by the driven gear 81 meshing therewith, to drive the cam 82 on the cam gear shaft 8 to rotate, so as to drive the piston connecting rod 7 to reciprocate in the air storage chamber 2b to inflate the air cylinder 2. By inflating the air storage chamber 2b, it is possible to increase air in the working air chamber 2a connected therewith (a check valve is disposed between the working air chamber 2a and the air storage chamber 2b), thereby increasing a firing force of the firing pin 9.

The description above merely relates to preferred embodiments of the present disclosure, and is not intended to limit the implementations and the scope of protection of the present disclosure. It should be appreciated by those skilled in the art that solutions obtained from equivalent substitutions and obvious variations made using the description and the drawings of the present disclosure shall be included in the scope of protection of the present disclosure.

1. An air inflation and storage structure of an air cylinder for a pneumatic tool, comprising a pneumatic tool body, an air cylinder being disposed in the pneumatic tool body, wherein a working air chamber and an air storage chamber connectable to each other are disposed in the air cylinder, a driving device is disposed in the pneumatic tool body, the driving device is connected to a driving shaft, the driving shaft is provided with an air inflation and storage driving member and a firing pin lift driving member adjacent to each other, the air inflation and storage driving member and the firing pin lift driving member are both configured to rotate unidirectionally and are configured to rotate in opposite directions, and a piston connecting rod driven to reciprocate by the air inflation and storage driving member is disposed in the air storage chamber,
wherein the air inflation and storage driving member is a driving gear meshing with a driven gear, the driven gear is disposed on a cam gear shaft, a cam is also disposed on the cam gear shaft, and an end of the piston connecting rod is connected to the cam.

2. (canceled)

3. The air inflation and storage structure of an air cylinder for a pneumatic tool according to claim 1, wherein a mounting bracket is disposed in the pneumatic tool body, and the cam gear shaft is rotatably mounted on the mounting bracket.

4. The air inflation and storage structure of an air cylinder for a pneumatic tool according to claim 3, wherein the mounting bracket is provided with a guard formed outside the cam gear shaft.

5. The air inflation and storage structure of an air cylinder for a pneumatic tool according to claim 4, wherein a unidirectional bearing is disposed between the driving shaft and the air inflation and storage driving member, and a unidirectional bearing is also disposed between the driving shaft and the firing pin lift driving member.

6. The air inflation and storage structure of an air cylinder for a pneumatic tool according to claim 5, wherein the driving device is a motor, and a speed reducer is connected to the motor.

7. The air inflation and storage structure of an air cylinder for a pneumatic tool according to claim 6, wherein the firing pin lift driving member cooperates with a firing pin, and a tail end of the firing pin is disposed within the working air chamber.

8. The air inflation and storage structure of an air cylinder for a pneumatic tool according to claim 7, wherein the working air chamber and the air storage chamber are arranged in parallel.

9. The air inflation and storage structure of an air cylinder for a pneumatic tool according to claim 5, wherein
when the motor rotates forwardly, the driving shaft drives the firing pin lift driving member to rotate, with the air inflation and storage driving member not rotating; the firing pin lift driving member is provided with a driving block and a plurality of driving posts spaced apart from each other, and a firing pin is provided with a bump and a rack; the driving block transmits a force to the bump of the firing pin via a transition member to complete a first-stage lifting of the firing pin; the firing pin lift driving member continues to rotate, and the driving posts act one by one on corresponding teeth of the rack of the firing pin to complete a second-stage lifting of the firing pin;
when the motor rotates reversely, the driving shaft drives the air inflation and storage driving member to rotate, with the firing pin lift driving member not rotating; and the air inflation and storage driving member drives the cam gear shaft to rotate by the driven gear meshing therewith, to drive the cam on the cam gear shaft to rotate, so as to drive the piston connecting rod to reciprocate in the air storage chamber to inflate the air cylinder.

10. A pneumatic tool, comprising an air inflation and storage structure of an air cylinder for a pneumatic tool according to claim 5.

11. The pneumatic tool according to claim 10, wherein the driving device is a motor, and a speed reducer is connected to the motor.

12. The pneumatic tool according to claim 11, wherein the working air chamber and the air storage chamber are arranged in parallel.

13. The pneumatic tool according to claim 12, wherein when the motor rotates forwardly, the driving shaft drives the firing pin lift driving member to rotate, with the air inflation and storage driving member not rotating; the firing pin lift driving member is provided with a driving block and a plurality of driving posts spaced apart from each other, and a firing pin is provided with a bump and a rack; the driving block transmits a force to the bump of the firing pin via a transition member to complete a first-stage lifting of the firing pin; the firing pin lift driving member continues to rotate, and the driving posts act one by one on corresponding teeth of the rack of the firing pin to complete a second-stage lifting of the firing pin;
when the motor rotates reversely, the driving shaft drives the air inflation and storage driving member to rotate, with the firing pin lift driving member not rotating; and the air inflation and storage driving member drives the cam gear shaft to rotate by the driven gear meshing therewith, to drive the cam on the cam gear shaft to rotate, so as to drive the piston connecting rod to reciprocate in the air storage chamber to inflate the air cylinder.
